(19) United States
(12) Patent Application Publication
(10) Pub. No.: US 2012/0316931 A1
(43) Pub. Date: Dec. 13, 2012

(54) GPS TRACKING WITH CARTOGRAPHIC BOUNDARY FILES

(76) Inventors: Casey Conlan, San Juan Capistrano, CA (US); Jason Gann, Lake Forest, CA (US)

(21) Appl. No.: 13/590,864

(22) Filed: Aug. 21, 2012

Related U.S. Application Data
(62) Division of application No. 12/766,777, filed on Apr. 23, 2010.

(51) Int. Cl. G09G 5/00; G06Q 10/00

(52) U.S. Cl. 705/7.42; 345/634

(57) ABSTRACT

The management of tracking units with a map representative of a geographic area is provided. A base address corresponding to a specific location on the map is received, and a plurality of boundary outlines circumscribing sub-segments of the map are generated. The boundary outlines correspond to cartographic boundaries within the geographic area, with each cartographic boundary having a predetermined number of fulfillment locations. An aggregate boundary outline based upon a selection of one or more contiguous boundary outlines is generated. Fulfillment indicators representative of a position on the map generally corresponding to the fulfillment locations is received, and overlaid on the map.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field

The present disclosure relates generally to geographic tracking in the context of delivering advertisements. More particularly, the present disclosure relates to GPS tracking with cartographic boundary files.

2. Related Art

Direct marketing, and in particular, direct-to-door marketing, refers to a highly localized form of advertising that involves the distribution of fliers, door hangers, brochures, catalogs, and the like without the use of more traditional advertising channels such as television, radio, and newspapers/magazines. As the name suggests, the material or product, which may include advertising but not limited thereto, is delivered directly to the recipient's place of residence or place of business, and is frequently employed by various enterprises of local and national scope. For example, sales or other promotional event held by a local franchisee of a national chain retailer may be communicated to area residents.

The targeting of direct-to-door marketing efforts is similar to that of direct mail marketing, in that penetration levels of potential recipients having certain attributes in specified geographic areas is first researched or otherwise obtained. The delivery of advertisement material is then limited to those geographic areas having the demographics and penetration levels matching the desired criteria. As an example, it may be desirable to distribute advertisements for products and services oriented towards the affluent in certain areas having a higher median income.

Due to the localized nature of direct marketing, companies providing such services have likewise been local to a geographic area. Accordingly, large-scale direct marketing efforts have relied upon a patchwork of different fulfillment teams to complete delivery, with an accompanying fluctuation in quality and distribution success. The viability of this marketing model is threatened by its reputation for unreliability, as some unscrupulous fulfillment teams have been caught dumping over 50% of the advertising material (referred to as product) intended to be delivered. The dumping of product is oftentimes difficult to find and prove. Furthermore, by definition, direct advertising is delivered only to a limited audience, and will thus have low response numbers. For these reasons and more, advertisers may be reluctant to utilize direct-to-door marketing.

As a way of combating dumping, many fulfillment vendors have begun to utilize global positioning satellite (GPS) receivers to track walkers, or those individuals that place the product on each door, and drivers. However, simple GPS tracking systems, without showing the geographical borders and the demographics/population of the campaign target area, do not have the capability to determine fulfillment. Thus, vendors have had difficulty in defending successful campaigns due to the lack of satisfactory evidence available from these conventional tracking systems.

In the GPS tracking context, the geographical borders of the campaign target area are known as geo-fences. Utilizing conventional mapping applications, one known method of defining geo-fences involves placing a geometric primitive, such as square, rectangles, circles, and so forth around the desired area. This, however, does not afford much flexibility in defining the geo-fences. Another known method for defining geo-fences involves building a complex vector line graphic in a separate drawing application, and uploading the resultant object into the GPS tracking system. Unfortunately, this method tends to be cumbersome, time-consuming, and expensive.

Accordingly, there is a need in the art for GPS tracking with cartographic boundary files. There is also a need in the art for an improved method for managing tracking units with a map representative of a geographic area, and an improved method for monitoring deliveries within a geographic constraint.

### BRIEF SUMMARY

In accordance with one embodiment of the present disclosure, a method for managing tracking units with a map representative of a geographic area is contemplated. The method may begin with a step of receiving a base address corresponding to a specific location on the map. There may also be a step of generating a plurality of boundary outlines circumscribing sub-segments of the map. The boundary outlines may correspond to cartographic boundaries within the geographic area, with each cartographic boundary having a predetermined number of fulfillment locations. The method may also include generating an aggregate boundary outline based upon a selection of one or more contiguous boundary outlines. There may also be a step of receiving a fulfillment indicator from a one of the tracking units. The fulfillment indicator may be representative of a position on the map generally corresponding to a one of the fulfillment locations. Furthermore, the method may include overlaying a fulfillment marker on the map based upon the received fulfillment indicator.

In accordance with another embodiment, a there is provided a method for monitoring deliveries within a geographic constraint. It may include defining the geographic constraint on a map from selected cartographic boundaries. The geographic constraints may have a predetermined number of delivery points. Additionally, the method may include receiving location coordinate data from one or more tracking units at a set frequency. The location coordinate data may be received as the tracking units traverse the delivery points within the geographic constraint. The method may further include displaying the map in a user interface. There may also be a step of overlaying markers on the map. The position of the markers may correspond to the received location coordinate data.

The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a block diagram showing one exemplary environment in which the method for managing tracking units may be implemented in accordance with various embodiments of the present disclosure;

FIG. 2 is an example user interface to a management application showing a map and base address input;

FIG. 3 is a flowchart illustrating one embodiment of a method for managing tracking units;

FIG. 4 is a flowchart illustrating an embodiment of a method for monitoring deliveries within a geographic constraint;

FIG. 5 is the example user interface showing the map and a set of range perimeters along predefined distances from the base address;

FIG. 6 is the example user interface showing the map with a plurality of boundary outlines overlaid thereon;

FIG. 7 is the example user interface showing the map with differently coded boundary outlines based on penetration levels;

FIG. 8A is the example user interface showing the map with selected boundary outlines that define an aggregate boundary outline;

FIG. 8B is the example user interface showing the map with the aggregate boundary outline further divided into distribution maps;

FIG. 9 is the example user interface showing the map with markers representative of the tracking units;

FIG. 10 is the example user interface showing the map of a successfully completed campaign; and

FIG. 11 is an example of a productivity report of various personnel involved in the completed distribution.

Common reference numerals are used throughout the drawings and the detailed description to indicate the same elements.

### DETAILED DESCRIPTION

The detailed description set forth below in connection with the appended drawings is intended as a description of certain embodiments of the present disclosure, and is not intended to represent the only forms that may be developed or utilized. The description sets forth the various functions in connection with the illustrated embodiments, but it is to be understood, however, that the same or equivalent functions may be accomplished by different embodiments that are also intended to be encompassed within the scope of the present disclosure. It is further understood that the use of relational terms such as top and bottom, first and second, and the like are used solely to distinguish one entity from another without necessarily requiring or implying any actual such relationship or order between such entities.

A mapping system utilizing overlaid cartographic boundary files for tracking global positioning system (GPS) units is contemplated in accordance with various embodiments of the present disclosure. The mapping system implements a method for managing tracking units with a map representative of a geographic area, as well as a method for monitoring deliveries within a geographic constraint. These methods may be implemented as one or more computer-executable instructions stored on a storage medium.

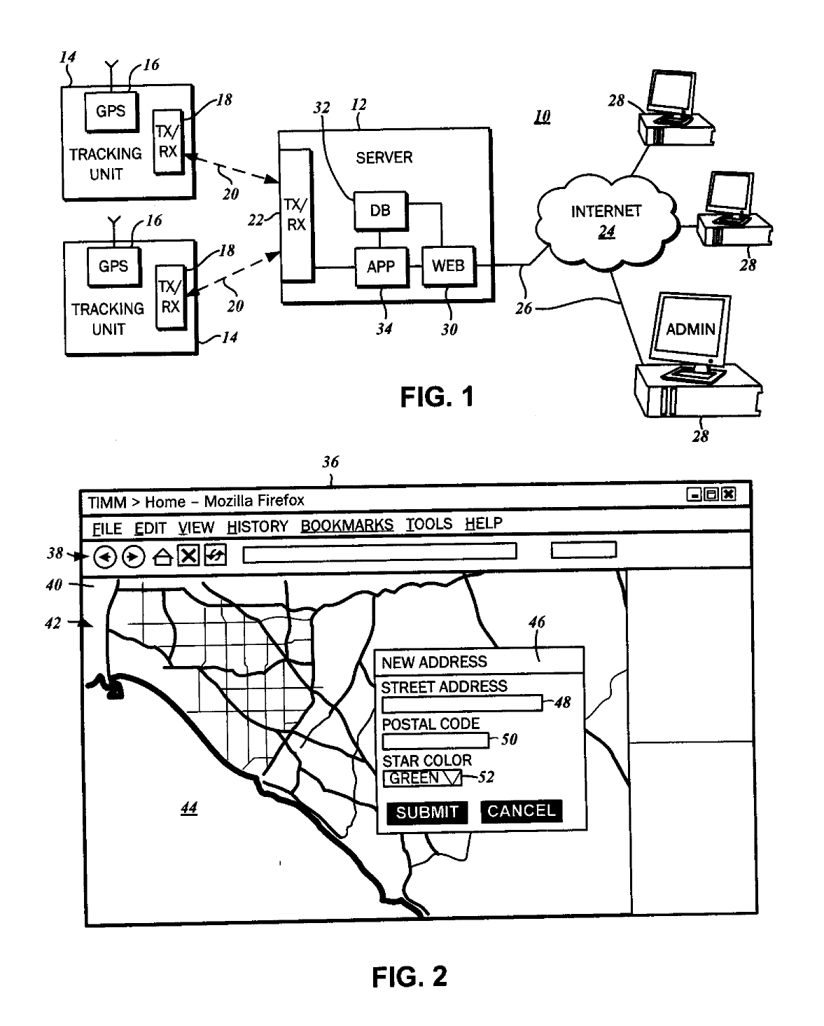

The block diagram of FIG. 1 shows an exemplary environment 10 in which the aforementioned methods may be implemented. Specifically, a server computer system 12 is in communication with one or more GPS tracking units 14. It is understood that the GPS tracking units 14 include conventional GPS receiver modules 16 that are adapted to derive geographic position coordinate data from signals received from a set of geostationary satellites according to well-developed and well-known techniques. The use of GPS-derived systems is presented by way of example only, and any other navigation system capable of deriving coordinate data, either existing or developed in the future, may be substituted.

The GPS tracking units 14 also include transceivers 18 for communicating with the server 12 over communication links 20. In this regard, the server 12 includes a corresponding transceiver 22 that connects to the tracking unit transceivers 18. The transceiver 22 of the server 12 and the transceivers 18 of the GPS tracking units 14 are understood to implement the same protocols such that reliable communications is possible over the links 20. Reference to the communication links 20 and the transceivers 18, 22 are made in their broadest sense; the communications link 20 may be of any type, wired or wireless, including USB, WiFi, and the like, with corresponding transceivers 18, 22 having features conforming to the standards. For example, the GPS tracking units 14 may be basic recorders that do not have live transmission capabilities, but with the coordinate data being transferred at a later time. Those having ordinary skill in the art will be able to ascertain the necessary modifications to implement the method for managing tracked units if such recording units are utilized.

Furthermore, the communications link 20 between the tracking units 14 and the server 12 need not be direct and utilize a dedicated transceiver as pictured, but instead traverse a number of interconnect devices. For example, a cellular phone based network such as 3G EDGE or CDMA may be used to transmit data wirelessly over an Internet Protocol link to the Internet 24, to which the server 12 is also connected over an Internet link 26.

Even in embodiments where the tracking units 14 are not communicating with the server 12 over the Internet 24, the server 12 is nevertheless connected to the Internet 24. It is contemplated that the server 12 is configured as a web server, such that a remote client computer 28 may access data stored thereon with a conventional web browser application well known in the art. Accordingly, the server 12 includes a web server module 30 that receives requests for specific data stored on, for example, a database 32, or otherwise generated by the server 12, retrieves the requested data, and transmits the data to the requestor. The server 12 also includes an application server module 34 that further extends the interactivity and web-accessible data processing capabilities of the server 12. The application server module 34 and/or the web server module 30 may receive data via the transceiver 22, which, as indicated above, may be integrated into the server 12.

It is contemplated that the functionality of the mapping system is implemented on the server 12 in connection with its constituent components, that is, the web server module 30, the database 32, the application server module 34, and others as necessary. The specifics of the server 12 are presented by way of example only and not of limitation, and any other configured data processing system may be substituted without departing from the scope of the present disclosure.

The remote client computer 28 is understood to be a general-purpose personal computer system capable of running various applications including the aforementioned web browser application, and is capable of connecting to the Internet 24. In general, the remote client computer 28 is understood to have input and output devices, data storage, and one or more processors. As will be appreciated by those having ordinary skill in the art, the remote client computer 28 may be of any suitable variation, and any number of different remote client computers 28 may communicate with the server 12.

The foregoing description of the various hardware components have been presented by way of example only and not of limitation, and any other suitable component may be substituted. Furthermore, the specific functionalities associated with such components are also exemplary; several different functions may be integrated into a single component, or various sub-parts of a single function may be performed by a number of different components.

FIG. 2 shows an exemplary user interface 36 of a web browser application with a web-based mapping system application loaded therein. In accordance with various embodiments, the browser user interface 36 is generated on the remote client computer 28. As will be readily recognized, the browser user interface 36 includes various browser controls 38 including back and forward buttons, reload buttons, bookmark menus, and so forth. Loaded within a primary browser window 40 is a web page that may be generated by the application server module 34 with data retrieved from the database 32. More particularly, a series of browser-side scripts and related data files in the HyperText Markup Language (HTML) may be transmitted by the web server module 30 to the remote client computer 28 when the web browser application is provided with the particular address of the server 12. The web browser application renders the received data in the primary browser window 40 and executes the scripts, thereby generating a mapping system user interface 42 therein. The scripts are receptive to user input, and can transmit requests and other data back to the server 12 in an interactive session. These capabilities can be implemented with Asynchronous JavaScript and XML (AJAX). Notwithstanding the foregoing, it is understood that embodiments of the present invention need not be limited to web-based implementations utilizing the Internet, and any other suitable remote communications framework may be readily substituted.

In accordance with one embodiment of the present disclosure, the mapping system user interface 42 may include a user-navigable map 44. The map 44 is a visual representation of a geographic area of interest, and depending on the selected zoom level, different levels of detail are shown. Various standard inputs provided to the mapping system user interface 42 by way of the browser user interface 36 are understood to correspond to panning and zooming operations on that map 44 that are performed in near real-time. The web application/user interface for the map 44 may be provided by the server 12, but it is more typical to utilize an existing third-party system such as Google® Maps, Yahoo!® Maps, MapQuest®, and the like by interfacing with available Software Development Kits. Data for the maps 44 may be provided by vendors such as TeleAtlas and NAVTEQ, and the entirety of the world may be covered.

With reference to the flowchart of FIG. 1, the method for managing tracking units begins with a step 200 of receiving a base address corresponding to a specific location on the map. Referring again to the mapping system user interface of FIG. 2, the mapping system user interface 42 generates an address query box 46 over the map 44, which includes a street address input 48, a postal code input 50, and a color selector 52. Once the requested information is entered and submitted to the server 12, the query box 46 disappears from view.

Based upon the inputted base address, the map 44 is refreshed and centered. According to one embodiment, the map 44 is zoomed to a level suitable to cover an area within a four mile radius of the center or inputted address fitted to the particular screen. Because the size of the browser user interface 36, as well as the size of the display device may vary, the relative size of the pertinent geographic features may vary. A center indicator 54 is overlaid on the map 44 at the inputted address, having a color as earlier specified via the color selector 52 in the address query box 46. By way of example shown in FIG. 2, the color selector 52 is a star, although any other suitable shape may be utilized.

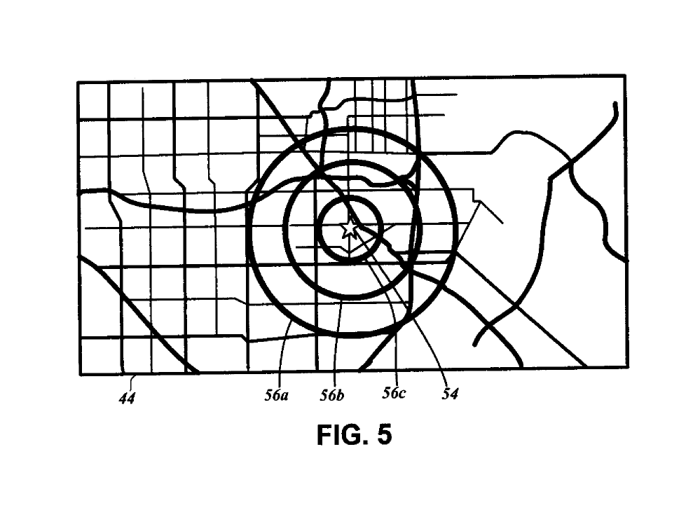

Preferably, though optionally, the method continues with a step 201 of generating one or more range perimeters 56a-c and overlaying the same on the map 44 as shown in FIG. 5 along predefined distances from the base address as designated by the center indicator 54. In one embodiment, the range perimeters 56a-c are circles that are defined by centers coincident with the base address. Additionally, such circles have radii corresponding to the predefined distances. According to the illustrated embodiment, these predefined distances are 1 mile, 2 miles, and 3 miles, though any other distances may be substituted. The outer range perimeter 56a is characterized by a 3 mile radius, the middle range perimeter 56b is characterized by a 2 mile radius, and the inner range perimeter 56c is characterized by a 1 mile radius. Besides radii, other ways of selecting regions within the map 44 are contemplated.

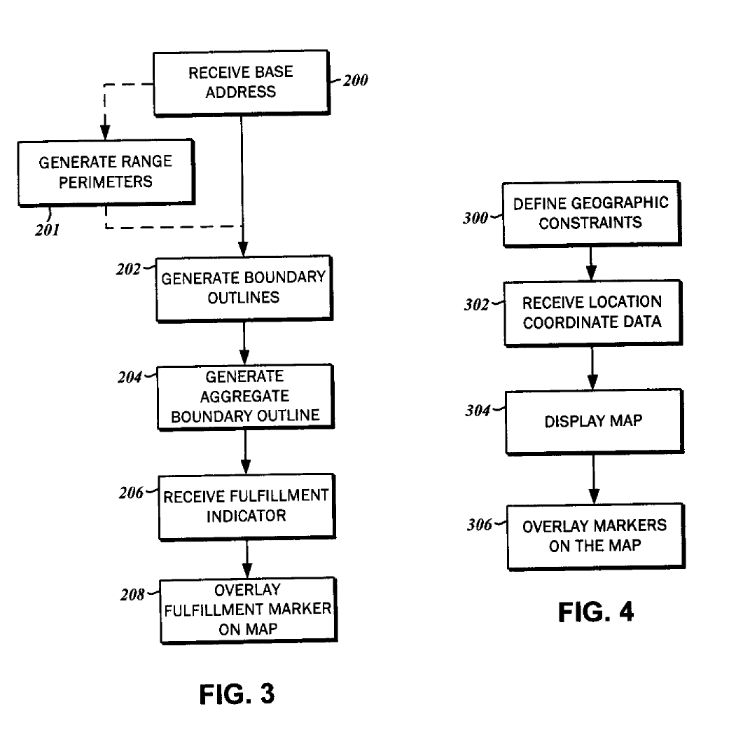

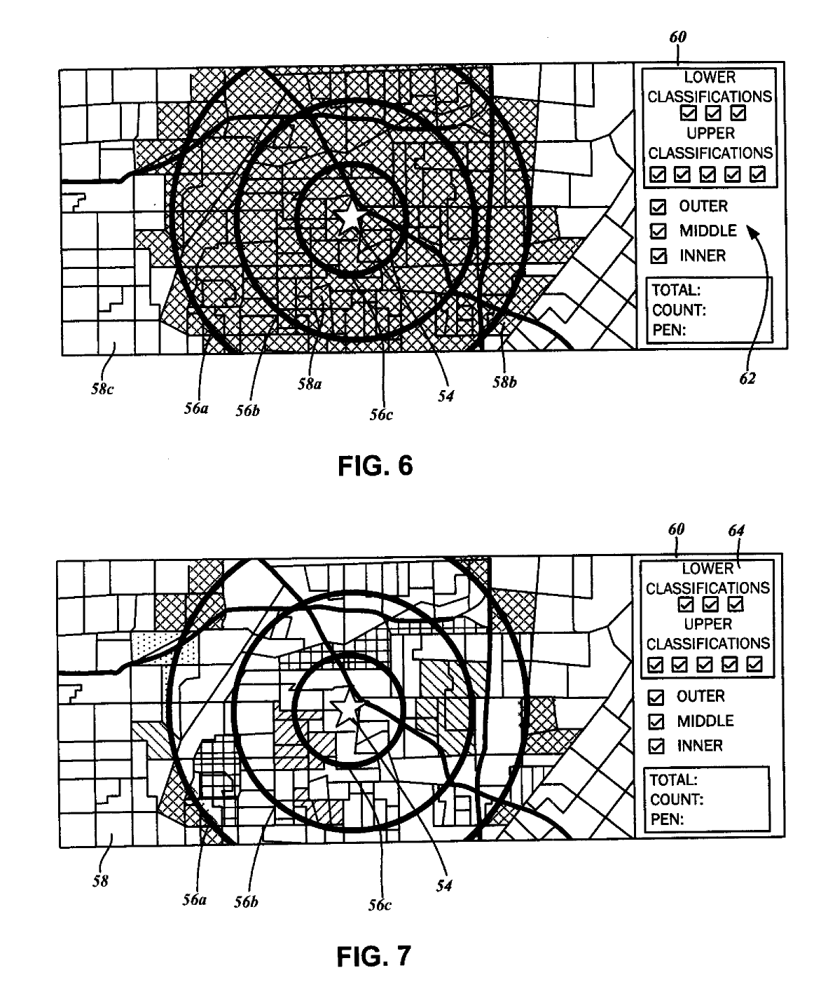

Referring again to the flowchart of FIG. 3 and the example mapping system user interface 42 shown in FIG. 6, the method continues with a step 202, of generating a plurality of boundary outlines 58 that circumscribe different sub-segments of the map. These sub-segments may represent different address blocks that are bounded by streets, natural landmarks, and other such cartographic features. Each of the sub-segments, that is, the boundary outlines 58, include a predetermined number of fulfillment locations or delivery points. One embodiment contemplates that the boundary outlines 58 correspond to Census block groups with each having a known number of households, though they may be based upon any division that can be imported from an external source. The boundary outlines 58 are overlaid on the map 44 as shown, and may be emphasized by a thicker border. Additionally, the inside of the boundary outlines 58 may have a different fill color or shading.

From the boundary outlines 58, an aggregate boundary is generated in accordance with step 204, thereby setting the geographic limits of the marketing campaign or distribution. In most cases, the aggregate boundary is generated from a manual selection of the desired boundary outlines 58. As a prefatory step, and in order to assist the administrator in visually selecting the proper boundary outlines 58, further processing and differentiation may be completed.

One such processing involves delineating the boundary outlines 58 that are encompassed by the range perimeters 56. It is understood that a boundary outline is encompassed by the range perimeter 56 if it is completely enclosed within the same, as is the case for a first boundary outline 58a. It is also understood that a boundary outline is encompassed by the range perimeter 56 if it is partially enclosed, that is, some portions of the boundary outline are inside, while other portions are outside, the range perimeter, as is the case for a second boundary outline 58b. This is understood to be true no matter how miniscule an amount the area within the boundary outline 58 falls inside the range perimeter 56, though it is also contemplated that the degree required to fall within the range perimeter 56 is adjustable. The boundary outlines 58 that are thus encompassed by the range perimeter 56 are colored or otherwise visualized differently from those that are not encompassed by the range perimeter 56, such as, for example, a third boundary outline 58c.

The mapping system user interface 42 includes a selection pane 60 that has, among others, boundary selection check boxes 62. By checking and un-checking the selection check boxes 62, the areas encompassed by the respective outer, middle, and inner boundary outlines 58a-c can be toggled. For example, by having all three selection check boxes selected, those boundary outlines 58 encompassed within the outer, middle, and inner boundary outlines 58a-c are differentiated as described above.

Another processing step that differentiates one boundary outline 58 from another for purposes of creating the aggregate boundary with the desired characteristics involves coding based on penetration levels. In relation to marketing concepts, penetration levels quantify the degree to which a particular product or service is utilized within a specific area from earlier research. These need not be directly related to the product or service being marketed in the campaign, and a variety of correlations between penetration levels for one class and anticipated response rates for another class may be made for distribution targeting.

Different boundary outlines 58 may be generated according to a number of classifications. Via a classification selection panel 64, one or more groups of boundary outline 58 may be selected. Among the selectable classifications include zipcodes, school districts, urban/country regions, and election districts, as well as others. This listing of selectable classifications is not intended to be limiting, and to the extent that data for such classifications are available, those may also be utilized. As shown in FIG. 7, different boundary outlines may be distinguished from others based upon such penetration levels. For purposes of the present disclosure, varying background patterns are used to show penetration levels, but in some contemplated embodiments, color may be utilized in stead. By way of example, penetration levels of 0%-20% may be assigned a blue color code, penetration levels of 20%-40% may be assigned a green color code, penetration levels of 40%-60% may be assigned a yellow color code, penetration levels of 60%-80% may be assigned an orange color code, and penetration levels of 80%-100% may be assigned a red color code. In addition to penetration levels, income levels and other demographic data from the Census bureau can be used to distinguish one boundary outline 58 from another. Similar to the cartographic data used to generate the base boundary outlines 58, the penetration level data may be imported from an external source.

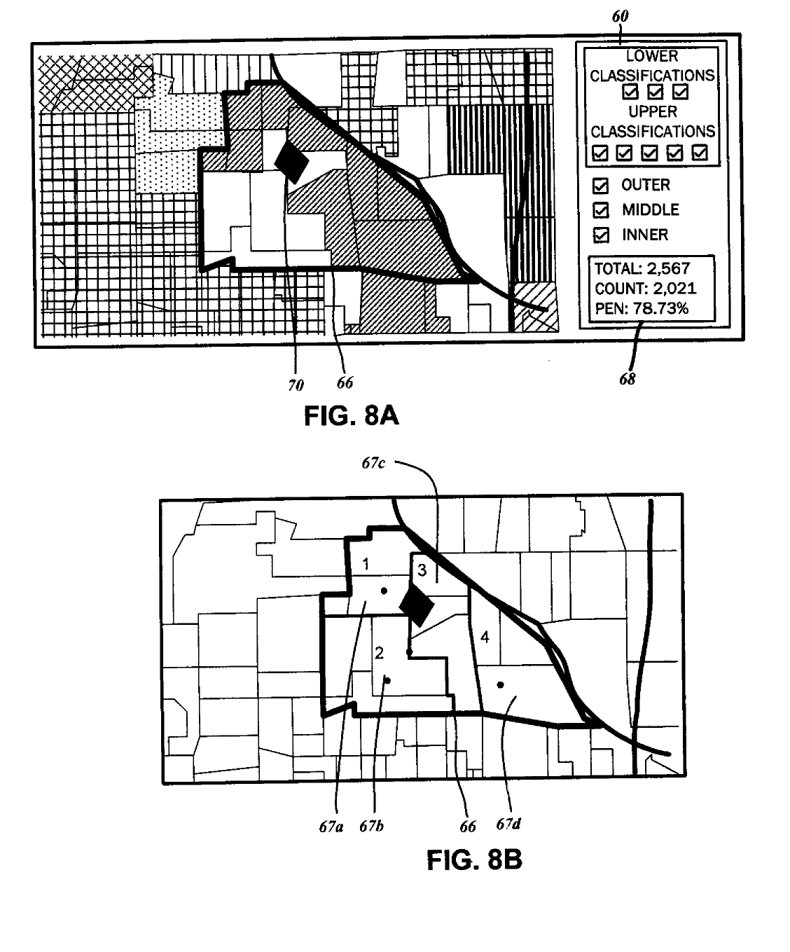

As briefly indicated above, the method for managing tracking units contemplates the step 204 of generating an aggregate boundary or submap. FIG. 8 best illustrates an aggregate boundary outline 66 being generated as the individual boundary outlines 58 are selected. Where the selected boundary outline 58 is contiguous with a previously selected one, the aggregate boundary outline 66 is expanded to include it. To the extent a non-contiguous boundary outline 58 is selected, a different aggregate boundary outline 66 is created. Thus, multiple aggregate boundary outlines 66 can be placed on the map 44. Upon selection of a boundary outline, information relating to the presently selected aggregate boundary outline 66 is displayed in a status panel 68. Any time the selection is changed, the status panel 68 may be updated. The displayed information includes the total number of households/delivery points, and the average penetration level of the selected boundary outlines 58, the area inside the aggregate boundary outline 66 in miles and kilometers, the average number of households per area, and so forth. Based upon this exemplary listing, those having ordinary skill in the art will be able to ascertain what other information can be calculated and displayed. By iteratively fine-tuning the selected boundary outlines 58 that form the aggregate boundary outline 66, a desired distribution can be developed.

Within the aggregate boundary outline 66, an exclusion zone 70 may also be defined in accordance with various embodiments of the present disclosure. In the context of direct marketing, the exclusion zone 70 is also understood to mean a do-not-deliver area. The exclusion zone 70 is separately defined from the boundary outlines 58, and may be defined in otherwise selected boundary outlines 58. The exclusion zone 70 is also visually distinguished from the rest of the area inside the aggregate boundary outline 66. Considering that non-contiguous boundary outlines 58 may be selected to define multiple aggregate boundary outlines 66, entire blocks represented by different boundary outlines 58 may be excluded from the distribution.

With reference to the flowchart of FIG. 4, the contemplated method for monitoring deliveries within a geographic constraint includes a step 300 of defining the geographic constraints from selected cartographic boundaries with that geographic constraint having a predetermined number of delivery points. This step is understood to generally correspond to steps 200, 202, and 204, and include the other prefatory procedures to step 204 described above. Once the aggregate boundary outlines 66 have been defined, that is, once the submaps have been created, they may be presented and assembled in different ways for use in the fulfillment process. Among other uses, the submaps may be printed for distribution to personnel as a visual aid in completing the distribution as planned.

It is also contemplated that multiple distribution maps within a single aggregate boundary outline 66 may be defined. For example, the number of fulfillment points within the aggregate boundary outline 66 may be 20,000, but it may be desirable to assign each fulfillment personnel to deliver 5,000. Accordingly, as shown in the map of FIG. 8, the area within the aggregate boundary outline 66 is segregated into five separate distribution maps 67a-67d, each approximately containing the desired 5,000 fulfillment points. In various embodiments, it is contemplated that the desired number of distribution maps is provided, and the appropriate distribution maps are calculated. Various methodologies may be utilized to generate the distribution maps, and selectable by an administrator.

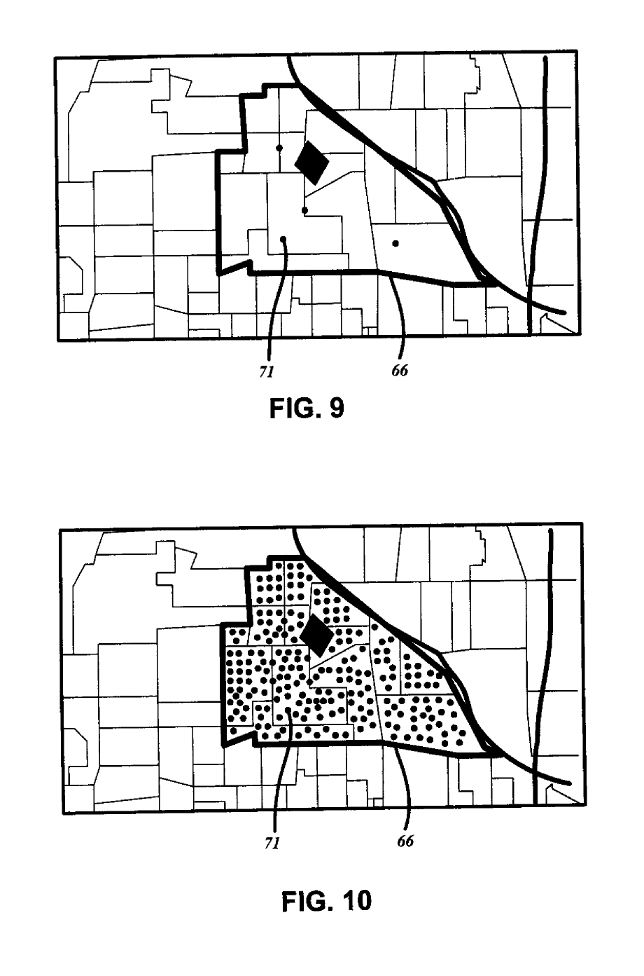

The method of managing tracking units 14 shown in the flowchart of FIG. 3 continues with a step 206 of receiving a fulfillment indicator from the tracking units 14. In general, the fulfillment indicator is representative of a position on the map 44 that generally corresponds to one of the fulfillment locations described above, i.e., households within a given area. More particularly, as best illustrated in the flowchart of FIG. 4 for the method for monitoring deliveries, this is understood to include receiving location coordinate data from the tracking units 14 per step 302. As mentioned above, once the fulfillment or delivery process has been started, the locations of all of the involved personnel are tracked with the GPS tracking units 14 to confirm that the direct marketing campaign is progressing as planned. Further, upon completion of delivery, it can be confirmed that the entirety of the area within the aggregate boundary outline 66 has been covered. The location coordinate data as generated by the tracking units 14 are uploaded to the server 12 in the manner described above. As shown in FIG. 9, and in accordance with step 208, a marker 71 corresponding to that location on the map 44 is overlaid in real-time. This is understood to correspond to step 304 of displaying the map in a user interface, and overlaying the markers thereon per step 306.

These steps are understood to be taken in relation to a tracking mode in which the personnel are monitored in real time. Other embodiments contemplated as described further below involve reporting after completion, which shows post-hoc the success of the distribution. The user interface for real-time tracking is shown in, for example, FIG. 9, while the user interface for the report is shown in, for example, FIG. 10.

In some contemplated embodiments, the tracking units 14 transmit location coordinate data at a set frequency as the personnel traverse the delivery points within the defined geographic constraint or aggregate boundary outline 66. Accordingly, it is possible to generate alerts when an anomaly is detected. For instance, an alert may be generated if one tracking unit sends a substantially identical location coordinate data at consecutive time intervals, for this is understood to be representative of a deliverer who has stopped moving. Another alert may be generated if a tracking unit sends coordinate data that are outside the aggregate boundary outline 66, since this is representative of a deliverer who is not following the established targets of the distribution. The alerts may include an e-mail or short message service (SMS) message sent to an administrator, or to the offending deliverer themselves. In addition to the alerts, other productivity measures such as average speed and covered distance can be calculated from the location coordinate data.

In accordance with conventional direct-to-door marketing practice, a fulfillment distribution may employ “walkers” going door-to-door to delivering the advertising materials, a “driver” who shuttles the walkers between distant locations, and “auditors” who monitor the walkers and the drivers and provide remedial instructions as necessary. It is contemplated that each of these categories of employees are assigned a tracking unit 14 and individually tracked in the same manner described above. With the location coordinate data and the productivity measures derived therefrom, a report that ranks the personnel can generated.

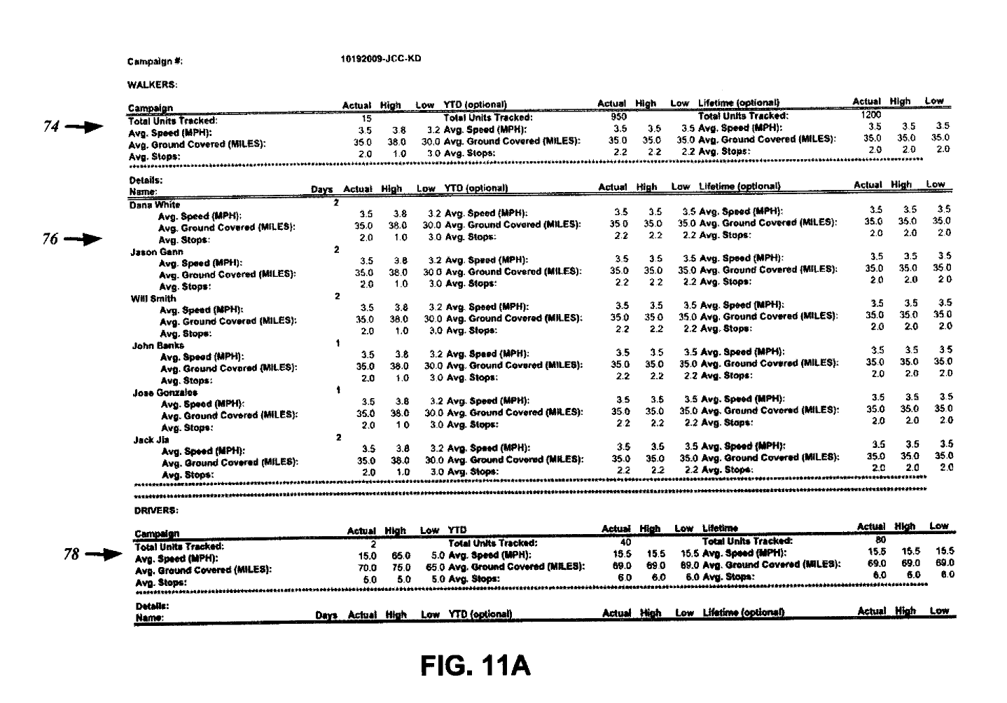

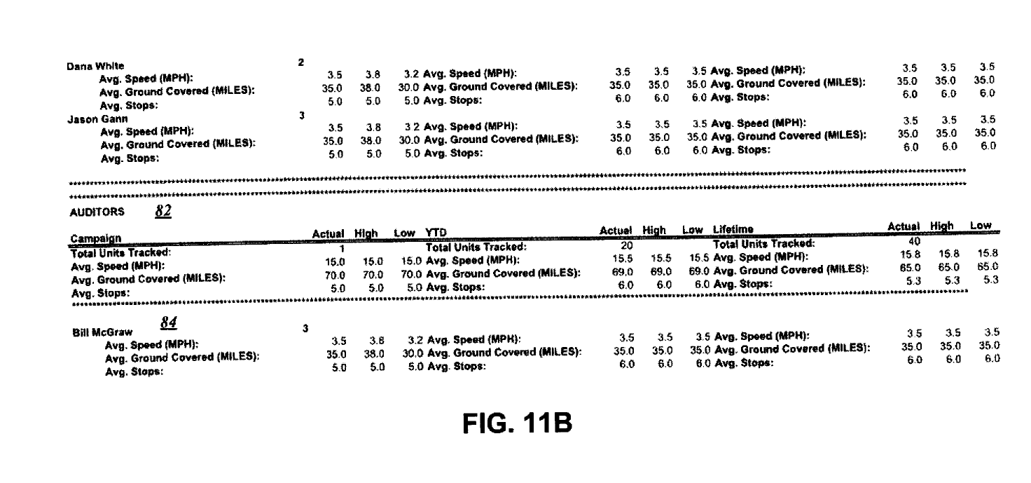

An example of such a report is shown in FIG. 11, with the walkers, drivers, and auditors being separately reported. Under a walker heading 74, the average speed, average distance covered, and the average number of stops for all of the walkers are shown. The highest and lowest recorded values of these measurements amongst the walkers are also shown. Optionally, the year-to-date totals, as well as the lifetime totals of these measurements are shown for comparison purposes. Under a walker detail heading 76, each of the walkers is listed by name, along with their average speed, average ground covered, and the average number of stops made. The ordering of the walkers may be according to ranking in a specific metric. Similar to the section of the report pertaining to the average of all walkers, the year-to-date and lifetime totals are produced for each of the walkers. The same metrics for drivers are similarly shown under a driver heading 78 and a driver detail heading 80, as well as for auditors under an auditor heading 82 and auditor detail heading 84. The formatting and content of the report are presented by way of example only and not of limitation, and any other desired report may be substituted without departing from the scope of the present disclosure.

As shown in FIG. 10, in addition to the above-described report, fulfillment success can be visually illustrated by overlaying each of the historical location coordinate data for all of the tracking units 14. This view of the map 44 is understood to include the aggregate boundary outline 66, and to the extent there were any defined, exclusion zones 70.

The particulars shown herein are by way of example only for purposes of illustrative discussion, and are presented in the cause of providing what is believed to be the most useful and readily understood description of the principles and conceptual aspects of the various embodiments set forth in the present disclosure. In this regard, no attempt is made to show any more detail than is necessary for a fundamental understanding of the different features of the various embodiments, the description taken with the drawings making apparent to those skilled in the art how these may be implemented in practice.

1. A method for managing tracking units with a map representative of a geographic area, comprising:
receiving a base address corresponding to a specific location on the map;
generating a plurality of boundary outlines circumscribing sub-segments of the map, the boundary outlines corresponding to cartographic boundaries within the geographic area each having a predetermined number of fulfillment locations;
generating an aggregate boundary outline based upon a selection of one or more contiguous boundary outlines;
receiving a fulfillment indicator from a one of the tracking units, the fulfillment indicator being representative of a position on the map generally corresponding to a one of the fulfillment locations; and
overlaying a fulfillment marker on the map based upon the received fulfillment indicator.

2. The method of claim 1, further comprising:
generating one or more range perimeters along predefined distances from the base address;
wherein one of the range perimeters encompasses the selected one or more contiguous boundary outlines.

3. The method of claim 2, wherein the selected one or more contiguous boundary outlines are completely enclosed within the one of the range perimeters.

4. The method of claim 2, wherein the selected one or more contiguous boundary outlines are partially enclosed within the one of the range perimeters.

5. The method of claim 2, wherein the range perimeters are circles defined by centers coincident with the specific location and radii of the predefined distances.

6. The method of claim 2, further comprising:
overlaying the range perimeters on the map.

7. The method of claim 1, wherein the cartographic boundaries are defined in accordance with census block groups.

8. The method of claim 1, wherein each of the cartographic boundaries within the geographic area has a penetration level associated therewith.

9. The method of claim 8, further comprising:
color-coding interiors of the boundary outlines in accordance with the associated penetration level.

10. The method of claim 1 further comprising:
receiving an exclusion region within the aggregate boundary outline, the exclusion region corresponding to a subsection of the geographic area having no fulfillment locations.

11. The method of claim 10, further comprising:
overlaying the exclusion region on the map.

12. The method of claim 1, further comprising:
deriving a fulfillment total from a sum of each of the fulfillment locations within the aggregate boundary outline.

13. The method of claim 1, wherein fulfillment indicators are received from a plurality of tracking units traversing a subsection of the geographic area represented by the aggregate boundary outline for a defined period of time.

14. The method of claim 13, further comprising:
ranking personnel associated with the tracking units according to a productivity criterion.

15. The method of claim 13, wherein:
the tracking units send fulfillment indicators in real-time; and
the fulfillment markers are overlaid on the map upon receipt from the tracking units.

16. The method of claim 1, further comprising:
overlaying historical fulfillment markers on the map, the historical fulfillment markers corresponding to the received fulfillment indicators over a predefined period of time.

17. (canceled)

18. (canceled)

19. (canceled)

20. (canceled)

21. (canceled)

22. (canceled)

23. (canceled)

24. (canceled)

25. (canceled)

26. An article of manufacture comprising a program storage medium readable by a computer, the medium tangibly embodying one or more programs of instructions executable by the computer to perform a method for managing tracking units with a map, comprising:
receiving a base address corresponding to a specific location on the map;
generating a plurality of boundary outlines circumscribing sub-segments of the map, the boundary outlines corresponding to cartographic boundaries within the geographic area each having a predetermined number of fulfillment locations;
generating an aggregate boundary outline based upon a selection of one or more contiguous boundary outlines;
receiving a fulfillment indicator from a one of the tracking units, the fulfillment indicator being representative of a position on the map generally corresponding to a one of the fulfillment locations; and
overlaying a fulfillment marker on the map based upon the received fulfillment indicator.
